(19) United States
(12) Patent Application Publication
(10) Pub. No.: US 2021/0345220 A1
(43) Pub. Date: Nov. 4, 2021

(54) RELAY FOR CONVERGENCE BETWEEN MULTI-HOP GEOGRAPHICAL ROUTING AND CELLULAR ROUTING

(71) Applicant: PSA AUTOMOBILES SA, Poissy (FR)

(72) Inventors: Saleh BENSATOR, ISSY LES MOULINEAUX (FR); Stefano MAFRICA, PARIS (FR); Alain SERVEL, JOUY EN JOSAS (FR)

(21) Appl. No.: 17/266,919

(22) PCT Filed: Jul. 4, 2019
(86) PCT No.: PCT/FR2019/051653

§ 371 Date: Feb. 8, 2021

(30) Foreign Application Priority Data
Aug. 10, 2018 (FR) 1857450

(51) Int. Cl. H04W 40/22; H04W 4/40; H04W 4/80

(52) U.S. Cl. CPC H04W 40/22; H04W 84/005; H04W 4/80; H04W 4/40

(57) ABSTRACT

The invention relates to a method for relaying an item of useful data by way of a transit station (SR), the item of useful data passing via the transit station from a first station (S1) to a second station (S2), wherein a station is a vehicle, a road infrastructure or a personal device of a pedestrian.

### CROSS-REFERENCE TO RELATED APPLICATIONS

This application is the US National Stage under 35 USC § 371 of International Application No. PCT/FR2019/051653, filed 4 Jul. 2019 which claims priority to French Application No. 1857450 filed 10 Aug. 2018, both of which are incorporated herein by reference.

### BACKGROUND

The present invention relates to the field of communication protocols dedicated to connected vehicles. It relates particularly to a communication protocol for relaying an item of useful data between multi-hop geographic routing and cellular routing, and vice versa.

It is particularly advantageous for interfacing a short-range network specific to connected vehicles, such as a network defined by the ETSI ITS-G5 standard, based on multi-hop geographic routing and a cellular network, such as an LTE network.

A short-range network specific to connected vehicles is typically a Car2X network, for “car to everything,” or also “V2X,” for “vehicle to everything.” In particular, such networks support “Car2Car,” (car-to-car) communications, “Car2Infrastructure” (car-to-infrastructure) communications, or also “Car2Pedestrian” (car-to-pedestrian) communications.

The term “vehicle” is understood to mean any type of vehicle such as a motor vehicle, a moped, a motorcycle, a wheelbarrow, a vehicle on rails, etc. The term “connected vehicle” is understood to mean any type of vehicle that is capable of exchanging data, for example via a radio frequency link, with any other type of connected entity, such as a base station of a cellular network, another vehicle, a road infrastructure, a personal device of a pedestrian, etc.

The expression “personal device of a pedestrian” is understood to mean any device of the pedestrian that is configured to exchange data. A smartphone, a laptop, a connected key, a chip that is implanted under the skin, etc., are therefore examples of personal pedestrian devices.

Sending and receiving data to and from a vehicle cannot be achieved simply by transposing the technologies that are known in the field of mobile telephony to the vehicle.

Thus, in mobile telephony, the notion of “best effort” is the benchmark with regard to the expected reliability in the transfer of data. Telecommunications protocols are configured to maximize the chances that data are actually transmitted. It is, in a way, an obligation of means but not an obligation of result.

In the field of connected vehicles and, in particular, in anticipation of autonomous driving wave 4 and above, an obligation of means is not sufficient. For example, it is not conceivable for an autonomous vehicle not to receive the indication that an emergency vehicle is approaching at full speed because the autonomous vehicle happens to be in an area that is not covered by a base station of a cellular network at that moment.

In order to make secure data exchanges possible (obligation of result), communication protocols that are specific to communications between road users (Car2X communications) have been put in place.

In the following, the term “station” is used to designate the road users involved in Car2X communications. Therefore, a “station” refers to a vehicle, a road infrastructure, or a personal device of a pedestrian.

These specific protocols relate to short-range ad-hoc networks in which data are exchanged directly between stations. For such short-range networks, the routing of data between stations is geographic. The geographic component is in fact necessary in order to identify the stations involved in a communication and to address the communication to them. As mentioned above, one example of a standard that supports such protocols is ETSI ITS-G5. In particular, the management of multi-hop geographic routing is provided by the Geonetworking layer in the ETSI ITS-G5 standard (in particular, see the document ETSI EN 302 636-4-1 V1.2.1). Other standards exist, including components of ETSI ITS-G5 such as the Geonetworking layer.

One important aspect of these networks is the fact that the geographic routing between stations is direct. Such routing is referred to particularly as multi-hop routing. In particular, this means that the stations are configured to exchange data directly with one another without going through a base station of a cellular network, for example.

Thus, taking the example of the autonomous vehicle that is not covered by the base station, multi-hop geographic routing makes it possible for the indication of the emergency vehicle to be transmitted, typically directly.

The ranges provided for such protocols are limited. In multi-hop routing, in order to increase this range, an item of useful data to be transmitted can pass through various other stations, which thus act as transit stations, in order to finally be routed to the destination station of the item of useful data (or to a geographic area comprising a plurality of destination stations).

The expression “item of useful data” is understood to mean any data or information that is intended to be transmitted. The notion of useful data is not limited and can also refer to information used by a computer program such as an autonomous driving algorithm, an acknowledgment of receipt of any type of protocol data unit (PDU), information for verifying the integrity of a PDU, etc.

In the following, the concepts of telecommunications used are given with reference to the OSI (Open Systems Interconnection) model.

However, such short-range networks pose problems.

In particular, the situation in which there is a great distance between the transmitting station—referred to here as the first station—and the destination station—referred to here as the second station—is problematic.

On the one hand, the possibility exists that no station is present between the first vehicle and the second vehicle in order to act as a relay. The transmission of the item of useful data is then impossible.

On the other hand, in the event that stations are available to act as relays, the latency introduced by the presence of numerous relays can be problematic.

### SUMMARY

The present invention is here to improve the situation.

To this end, a first aspect relates to a method for relaying an item of useful data by way of a transit station, the item of useful data passing through the transit station from a first station to a second station, a station being a vehicle, a road infrastructure, or a personal device of a pedestrian, the method comprising the steps, implemented by the transit station, of:
receiving—from the first station and by means of a short-range network based on multi-hop geographic routing—a packet, called a geo-network packet, the geo-network packet comprising the item of useful data and being configured to be routed by the multi-hop geographic routing of the short-range network;
processing the geo-network packet in order to generate a packet, called a cellular packet, the cellular packet comprising the item of useful data and being configured to be routed by cellular routing via at least one base station within a cellular network, the processing being implemented by a layer that is lower than or equal to the network layer;
transmitting the cellular packet to the second station via the cellular network.

The method according to the first aspect thus makes it possible to relay data received via multi-hop geographic routing and retransmitted via cellular routing.

The problems of limited coverage and of latency caused by the use of a short-range network based on multi-hop geographic routing are thus solved.

This is because, in situations in which there is a great distance between the first station and the second station, the method makes it possible to use the cellular network on the basis of cellular routing. The architecture of such a cellular network then facilitates transmission over long distances, the latency is reduced, and the range is no longer constrained by the presence of other stations between the first and the second vehicle.

In addition, since the processing of the geo-network packet in order to generate the cellular packet is implemented in the network layer or below, the transit steps within the transit station are advantageously reduced. In particular, it is not necessary to double the processing steps of the transport and upper layers, which are very costly in terms of time and computing resources. For example, it is not necessary to sign the segments/datagrams for the short-range network and for the cellular network.

Such signature steps are particularly cumbersome for networks in charge of communications between stations in the form of a vehicle, a road infrastructure, and/or a personal device of a pedestrian. Thus, the processing of cooperative awareness messages (CAMs) and of decentralized environmental notification messages (DENMs), or also the RSA signatures introduce delays of approximately 30 ms in the layers above the network layer for segments that are intended to be sent by multi-hop geographic routing.

This effect of rationalizing the processing steps is also multiplied to the extent that a plurality of transit stations may be interposed between the first station and the second station.

The relay implemented in this manner by the network or lower layer thus significantly improves the possibilities for communications between stations—and efficiently at that.

The concepts of “reception from the first station” and “transmission to the second station” are not limited to direct exchanges. This means that intermediaries, and typically other transit stations, may be present between the first station and the transit station and between the transit station and the second station.

In addition, “processing the geo-network packet in order to generate a cellular packet” is understood to mean any type of processing that uses the geo-network packet in particular in order to generate, in particular, the cellular packet. This feature is therefore not limited to the generation of a single cellular packet by a single geo-network packet but also covers the generation of a cellular packet by a plurality of geo-network packets and other data or even the generation of multiple cellular packets from a single geo-network packet.

The term “road infrastructure” is understood to mean any infrastructure for any type of vehicle that is linked to or located in an environment close to a road. A toll barrier, a sign, a fence in a park, or even a processing center in charge of roads that is located in a particular geographic area are examples of road infrastructures.

The expression “to a second station” is understood to mean that the packet is sent particularly or exclusively to the second station. It can thus be a unicast, multicast, broadcast transmission to one or more stations identified by an address on a telecommunications network, a geographic position, an operating parameter, etc.

In one embodiment, the step of processing the geo-network packet comprises the sub-steps of:
generating information for cellular routing through the base station within the cellular network;
adding to the geo-network packet a header comprising the information for cellular routing.

Filling the header of the cellular packet in the network layer or lower directly from the geo-network packet advantageously reduces the processing steps in the layers above the network layer. Once again, the reduction of the processing steps is all the more important given that numerous transit stations may be present between the first and the second station.

In particular, in one embodiment, the geo-network packet comprises the item of useful data and information for the multi-hop geographic routing, and in which the information for cellular routing is obtained from the information for geographic routing. Since the information required for cellular routing is obtained directly from the geo-network packet, the number of entities from which the generation of the cellular packet is requested is advantageously limited.

In one embodiment, the step of adding the header to the geo-network packet comprises concatenating the header comprising the information for cellular routing to the geo-network packet. Concatenating the header is a very efficient method for enabling cellular routing, especially in terms of resources and computing time. It is worth noting that the optimization of the calculation time is particularly significant for the relay method.

In one embodiment, a verification of a transit authorization criterion is performed prior to the processing step, and the processing and transmission steps are not implemented in the event that the verification is negative,

wherein the transit authorization criterion is at least one of the following elements:
a fixed control parameter;
a variable control parameter;
a criticality parameter for the item of useful data;
a type of station.

In another embodiment, the transit authorization criterion comprises at least the variable control parameter,
wherein the variable control parameter is updated in at least one of the following situations:
   updating at the predetermined interval;
   updating during a station maintenance operation;
   powering-on of the station.

It may not be appropriate to have the item of useful data pass through a station. Indeed, since the stations belong to individuals (vehicle, personal device of a pedestrian) or to private companies (infrastructures), for example, and the transit involving a connection can be expensive, it is not always appropriate to allow the transit of the item of useful data.

Thus, using a control parameter makes it possible to control the transit of data through the station and can thus save the owner of the station from unwanted charges. The criticality parameter for the item of useful data makes it possible to prioritize the messages to be transmitted, enabling the most critical messages such as distress calls (e.g., B-CALL) to be, for example, systematically transmitted.

A second aspect relates to a method for relaying an item of useful data by way of a transit station, the item of useful data passing through the transit station from a first station to a second station, a station being a vehicle, a road infrastructure, or a personal device of a pedestrian, the method comprising the steps, implemented by the transit station, of:
reception from the first station and by means of a cellular network based on cellular routing via at least one base station of a packet, called a cellular packet, the cellular packet comprising the item of useful data and being configured to be routed by cellular routing within the cellular network;
processing the cellular packet in order to generate a packet, referred to as a geo-network packet, the geo-network packet comprising the item of useful data and being configured to be routed by multi-hop geographic routing on a short-range network, the processing being implemented by a layer that is lower than or equal to the network layer;
transmitting the geo-network packet to the second station via the short-range network.

Analogously to what was detailed above for a relay between multi-hop geographic routing and cellular routing, the second aspect thus makes a relay possible between cellular routing and multi-hop geographic routing.

Thus, a vehicle not covered by a base station of a cellular network can still be accessible via multi-hop geographic routing.

In an embodiment of the second aspect, the step of processing the cellular packet comprises extracting the geo-network packet from the cellular packet. In another embodiment of the second aspect, the extraction is performed by removing a header from the cellular packet, the header comprising information for cellular routing via the base station within the cellular network.

Analogously to the first aspect, the relay implemented in this manner by the network or lower layer significantly and effectively improves the possibilities of communication between stations.

In one embodiment, a verification of a transit authorization criterion is performed prior to the processing step, and the processing and transmission steps are not implemented in the event that the verification is negative,

wherein the transit authorization criterion is at least one of the following elements:
a fixed control parameter;
a variable control parameter;
a criticality parameter for the item of useful data;
a type of station.

In another embodiment, the transit authorization criterion comprises at least the variable control parameter,
the variable control parameter being updated in at least one of the following situations:
   updating at the predetermined interval;
   updating during a station maintenance operation;
   powering-on of the station.

It may not be appropriate to have the item of useful data pass through a station. Indeed, since the stations belong to individuals (vehicle, personal device of a pedestrian) or to private companies (infrastructures), for example, and the transit involving a connection can be expensive, it is not always appropriate to allow the transit of the item of useful data.

Thus, using a control parameter makes it possible to control the transit of data through the station and can thus save the owner of the station from unwanted charges. The criticality parameter for the item of useful data makes it possible to prioritize the messages to be transmitted, enabling the most critical messages, such as distress calls (e.g., B-CALL) to be, for example, systematically transmitted.

In an embodiment that is common to the first and second aspect, the short-range network is an ITS-G5 network, and/or the cellular network is a 2G mobile network (e.g., GSM and/or Edge), a 3G mobile network (e.g., UMTS or HSPA), a 4G mobile network (e.g., LTE), or a 5G mobile network.

A third aspect relates to a computer program comprising instructions for implementing the method according to the first aspect when these instructions are executed by a processor.

A fourth aspect relates to a device for relaying an item of useful data that is connected to a transit station, the item of useful data passing through the transit station from a first station to a second station, a station being a vehicle, a road infrastructure, or a personal device of a pedestrian, the device comprising at least one processor and one memory designed to perform the operations of:
reception from the first station and by means of a short-range network based on multi-hop geographic routing of a packet, called a geo-network packet, the geo-network packet comprising the item of useful data and being configured to be routed by the multi-hop geographic routing of the short-range network;
processing the geo-network packet in order to generate a packet, called a cellular packet, the cellular packet comprising the item of useful data and being configured to be routed by cellular routing via at least one base station within a cellular network, the processing being implemented on a layer that is lower than or equal to the network layer;
transmitting the cellular packet to the second station via the cellular network.

A fifth aspect relates to a device for relaying an item of useful data that is connected to a transit station, the item of useful data passing through the transit station from a first station to a second station, a station being a vehicle, a road infrastructure, or a personal device of a pedestrian, the device comprising at least one processor and one memory designed to perform the operations of:
receiving from the first station and by means of a cellular network based on cellular routing via at least one base station a packet, called a cellular packet, the cellular packet comprising the item of useful data and being configured to be routed by cellular routing within the cellular network;
processing the cellular packet in order to generate a packet, referred to as a geo-network packet, the geo-network packet comprising the item of useful data and being configured to be routed by multi-hop geographic routing on a short-range network, the processing being implemented by a layer that is lower than or equal to the network layer;
transmitting the geo-network packet to the second station via the short-range network.

A sixth aspect relates to a vehicle comprising the device according to the fourth and/or the fifth aspect.

### DESCRIPTION OF THE DRAWINGS

Other features and advantages of the invention will become apparent on examination of the detailed description that follows and from the drawings, in which:

FIG. 1 shows a context of application of relaying useful data from a first station to a second station by way of a transit station;

FIG. 2 shows a method according to an embodiment of the application;

FIG. 3 shows a method according to an embodiment of the application in the context of layers of a telecommunications network;

FIG. 4 shows a detection device according to one embodiment of the application.

### DETAILED DESCRIPTION

The invention will be described below in its non-limiting application to the case of motor vehicles communicating with one another, the vehicles hereinafter being called stations. The invention is not limited to such an illustrative application and can be implemented by a connected moped, a connected stroller, and the fence of a public garden, for example.

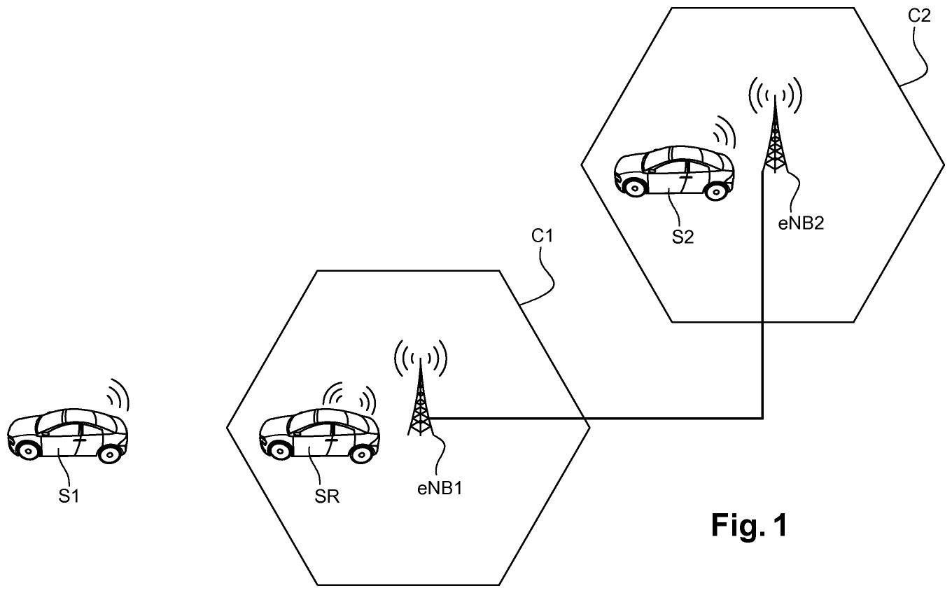

FIG. 1 shows the context of implementation of the method.

Three motor vehicles S1, S2, and SR are shown in FIG. 1 and are referred to hereinafter as first station S1, second station S2, and transit station SR, respectively.

The station S1 communicates with the transit station SR through a short-range network based on multi-hop geographic routing. One established example of such a short-range network is a network based on the ETSI ITS-G5 standard.

The stations SR and S2 communicate via a cellular network on the basis of cellular routing involving cells C1 and C2 and base stations eNB1 and eNB2.

The first aspect of the method covers in particular the relaying by the station SR of an item of useful data sent by the station S1 to the station S2. In this situation, the item of useful data is first transmitted via the short-range network from the station S1 to the transit station SR and then transmitted via the cellular network from the transit station SR to the second station S2.

The second aspect of the method, not shown, covers in particular the relaying by a transit station (not shown) of an item of useful data transmitted by a first station (not shown) to a second station (not shown). In this situation, the item of useful data is first transmitted via the cellular network from the first station to the transit station and then transmitted via the short-range network from the transit station to the second station.

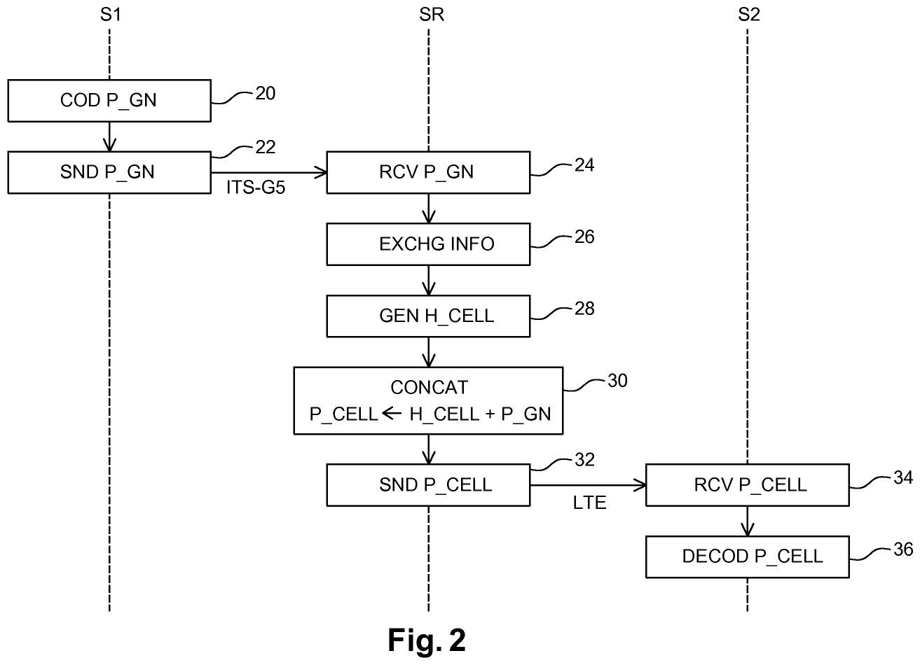

FIG. 2 shows an embodiment of the method.

In particular, FIG. 2 shows the method according to the first aspect. The method according to the second aspect is analogous to the method according to the first aspect and will be described below without being illustrated.

In the embodiment described here with reference to FIG. 2, the steps are carried out on the network layers of the stations S1, SR, and S2.

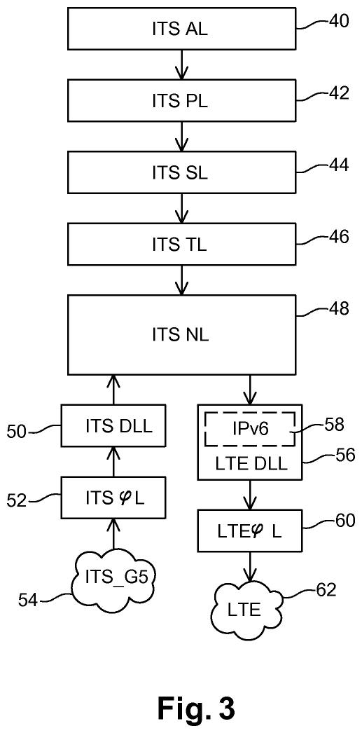

In particular, for stations S1, SR, and S2, the network layer is the layer 48 in FIG. 3. FIG. 3 also shows the application layer 40, the presentation layer 42, the session layer 44, and the transport layer 46.

FIG. 3 also shows the data link layer 50 for the short-range network, the physical layer 52 for the short-range network, and the short-range network 54.

Likewise, on the cellular side, FIG. 3 shows the data link layer 56 for the cellular network, the physical layer 60 for the cellular network, and the cellular network 62. The data link layer 56 for the cellular network has an IPv6 encapsulation sublayer 58.

In step 20, a packet P_GN, called a geo-network packet, is generated particularly from the useful data to be transmitted from the station S1 to the station S2. The item of useful data is received, for example, from an upper layer such as the transport layer.

In particular, at the level of the network layer, the geo-network packet is processed so that it can be transmitted over the short-range network, which is based on multi-hop geographic routing. This processing consists, for example, of the processing described by document ETSI EN 302 636-4-1 V1.2.1.

In step 22, the geo-network packet P_GN is sent from the station S1 to the station SR via the short-range network (ITS-G5, for example). At the level of the network layer, this means that the packet P_GN is transmitted to the lower layers (typically, the data link layer of the short-range network) in order to be sent over the short-range network and hence via multi-hop geographic routing.

The P_GN geo-network packet is received in step 24. At the level of the network layer, this means that the packet P_GN is received toward the lower layers (typically, the data link layer of the short-range network).

In one embodiment, a verification (not shown in FIG. 2) of a transit authorization criterion is performed prior to the processing step, the processing and transmission steps not being implemented in the event that the verification is negative.

The transit authorization criterion is at least one of the following elements:
a fixed control parameter;
a variable control parameter;
a criticality parameter for the useful data;
a type of station.

For example, the control parameters may simply include information as to whether or not transit is desired. If transit is not desired, when the authorization criterion has been checked, the method does not continue until steps 26 et seq. described below.

In the case of the criticality parameter for the useful data, the verification can be carried out packet by packet or on other levels (transport, data link layer, application, etc.). Verification can also be performed for groups of PDUs.

In another embodiment, the transit authorization criterion comprises at least the variable control parameter,
the variable control parameter being updated in at least one of the following situations:
   updating at the predetermined interval;
   updating during a station maintenance operation;
   powering-on of the station.

The maintenance operation typically corresponds to a situation in which the vehicle station is taken to a garage for servicing. The update data are typically received via any type of connection, for example wirelessly or via a diagnostic socket, such as the OBD (On Board Diagnostic) socket.

In step 26, information is exchanged with other layers, such as the “ITS Network and Transport Management” layer, for example. In particular, this exchanged information can make the relaying of the geo-network packet possible directly in the network layer and without going back to the upper layers.

In step 28, information for cellular routing via the base stations eNB1 and eNB2 is generated and integrated into a header H_CELL.

This information can be obtained from the packet P_GN. In particular, a header of the packet P_GN can be used to retrieve an identifier of the station S2 from which the information for cellular routing to the station S2 can be deduced. In addition, the identifier of the station S2 can be obtained from the information for the multi-hop geographic routing contained in the header of the packet P_GN.

In step 30, an addition to the geo-network packet P_GN of the header H_CELL comprising the information for cellular routing is implemented, whereby a cellular packet P_CELL is generated. In particular, the addition of the header to the geo-network packet may comprise concatenating the header comprising the information for cellular routing to the geo-network packet.

Thus, in steps 28 and 30, the geo-network packet P_GN is processed in order to generate the cellular packet P_CELL. In one embodiment, steps 28 and 30 are implemented by data link layer 58. In particular, these steps can be implemented by the layer 58, so that the cellular packet P_CELL is encapsulated according to the IPv6 protocol. In another example, the cellular packet P_CELL is encapsulated according to the IPv4 protocol.

In step 32, the cellular packet P_CELL is transmitted from the station SR to the station S2. At the level of the network layer, this means that the packet P_CELL is transmitted to the lower layers (typically, the cellular data link layer) in order to be sent over the cellular network, and hence the base stations eNB1 and eNB2, to the station S2.

The cellular packet P_CELL is then received by the station S2 in step 34 and then processed in step 36 so that the item of useful data is obtained.

Analogously, for the second aspect, and in one embodiment of the method, the item of useful data is relayed by a transit station from a first station to a second station, but the datum is received at the transit station via the cellular network and retransmitted from the transit station to the second station via the short-range network.

In this situation, a cellular packet is received by the transit station in order to be relayed to the second station. When received by the transit station, the cellular packet is processed in order to generate a geo-network packet that can be transmitted over the short-range network.

To this end, the processing step may include extracting the geo-network packet from the cellular packet. In particular, the extraction can be performed by deleting a header from the cellular packet, as the header comprises information for cellular routing.

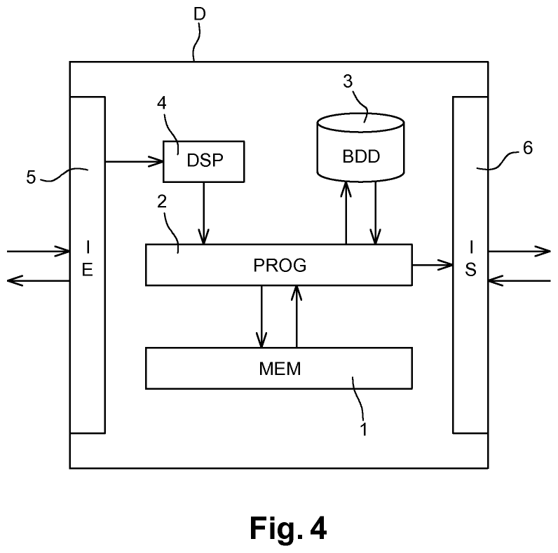

FIG. 4 shows an example of a device D of the station S1, SR, or S2. This device D can be used as a centralized device in charge of at least certain steps of the method carried out by the station S1, SR, or S2.

This device D can take the form of a box comprising printed circuits for any type of computer or even for a smartphone.

The device D comprises a random access memory 1 for storing instructions for the implementation by a processor 2 of at least one step of the method as described above. The device also comprises a mass memory 3 for storing data that are intended to be kept after the implementation of the method.

The device D may further comprise a digital signal processor (DSP) 4. This DSP 4 receives data in order to format, demodulate, and amplify these data in a manner that is inherently known.

The device also comprises an input interface 5 for receiving the data implemented by the method and an output interface 6 for the transmission of the data implemented by the method.

A first set of aspects related to the method described above is described below with reference to FIG. 2:

A. A method for transmitting a packet, called a cellular packet, from a first station, a station being a vehicle, a road infrastructure, or a personal device of a pedestrian, to a second station, the method comprising the steps of:
generating a packet, called a geo-network packet, from at least one segment, the segment coming from a transport layer or from a layer above the transport layer, the geo-network packet being configured to be routed by multi-hop geographic routing within a short-range network;
processing the geo-network packet in order to generate the cellular packet, the cellular packet being configured to be routed by cellular routing via a base station within a cellular network, the processing being implemented by a layer that is lower than or equal to the network layer;
transmitting the cellular packet to the second station via the cellular network.

The method according to aspect A. thus makes it possible to send a geo-network packet that is configured for multi-hop geographic routing via cellular routing.

The problems of limited coverage and of latency caused by the use of a short-range network based on multi-hop geographic routing are thus solved.

This is because, in situations in which there is a great distance between the first station and the second station, the method makes it possible to use the cellular network on the basis of cellular routing. The architecture of such a cellular network then facilitates transmission over long distances, the latency is reduced, and the range is no longer constrained by the presence of other stations between the first and the second vehicle.

In addition, since the processing of the geo-network packet in order to generate the cellular packet is implemented in the network layer or below, the steps implemented for transmission are advantageously reduced. In particular, it is not necessary to double the processing steps of the transport and upper layers, which are very costly in terms of time and computing resources. For example, it is not necessary to sign the segments/datagrams for the short-range network and for the cellular network.

Such signature steps are particularly cumbersome for networks in charge of communications between stations in the form of a vehicle, a road infrastructure, and/or a personal device of a pedestrian. Thus, the processing of cooperative awareness messages (CAMs) and of decentralized environmental notification messages (DENMs), or also the RSA signatures introduce delays of approximately 30 ms in the layers above the network layer for segments that are intended to be sent by multi-hop geographic routing.

The transmission implemented in this manner thus significantly—and efficiently—improves the possibilities for communication between stations, most particularly in terms of speed and processing efficiency.

The notion of “transmitting the cellular packet to the second station via the cellular network” is not limited to a direct exchange. This means that intermediaries, and typically transit stations, can be present between the first station and the second station. Furthermore, “transmission ( . . . ) via the cellular network” means that the packet is transmitted over the cellular network from the first station, but this does not necessarily mean that all links between transit stations are provided by the cellular network.

In addition, “processing the geo-network packet in order to generate a cellular packet” is understood to mean any type of processing that uses the geo-network packet in particular in order to generate, in particular, the cellular packet. This feature is therefore not limited to the generation of a single cellular packet by a single geo-network packet but also covers the generation of a cellular packet by a plurality of geo-network packets and other data or even the generation of multiple cellular packets from a single geo-network packet.

The term “road infrastructure” is understood to mean any infrastructure for any type of vehicle that is linked to or located in an environment close to a road. A toll barrier, a sign, a fence in a park, or even a processing center in charge of roads that is located in a particular geographic area are examples of road infrastructures.

B. The method according to aspect A., in which the cellular packet is transmitted to the data link layer or to the lower layer in the data link layer for transmission to the second station via the cellular network.

C. The method according to aspect B., the step of processing the geo-network packet comprises the sub-steps of:
generating information for cellular routing through the base station within the cellular network;
adding to the geo-network packet a header comprising the information for cellular routing.

D. A method for receiving a packet, called a cellular packet, by a second station, a station being a vehicle, a road infrastructure, or a personal device of a pedestrian, the cellular packet having been transmitted by a first station, the method comprising the steps of:
receiving, by the second station, the cellular packet transmitted by the first station, the cellular packet being configured to be routed by cellular routing via a base station within a cellular network;
extracting a packet, known as a geo-network packet, from the cellular packet, the geo-network packet being configured to be routed by multi-hop geographic routing within a short-range network, the extraction being implemented by a layer that is lower than or equal to the network layer;
generating a segment from the geo-network packet;

transmitting the segment to a transport layer or to a layer above the transport layer.

Analogously to what was detailed above for the transmission, the second aspect thus makes it possible to receive a cellular packet from which a geo-network packet is obtained.

E. The method according to at least one of aspects A. to D., in which the short-range network is an ITS-G5 network and/or the cellular network is a 2G mobile network, a 3G mobile network, a 4G mobile network, or a 5G mobile network.

F. A device comprised within a first station, a station being a vehicle, a road infrastructure, or a personal device of a pedestrian, for transmitting a packet, called a cellular packet, from the first station to a second station, the device comprising at least one processor and one memory configured to perform the operations of:
receiving a segment from a transport layer or from a layer above the transport layer;
generating a packet, called a geo-network packet, from the segment, the geo-network packet being configured to be routed by multi-hop geographic routing within a short-range network;
processing the geo-network packet in order to generate a packet, called a cellular packet, the cellular packet comprising the useful data and being configured to be routed by cellular routing via at least one base station within a cellular network, the processing being implemented by a layer that is lower than or equal to the network layer;
transmitting the cellular packet to the second station via the cellular network.

G. A device comprised within a second station, a station being a vehicle, a road infrastructure, or a personal device of a pedestrian, for receiving a packet, called a cellular packet, by the second station from a first station, the device comprising at least one processor and one memory configured to perform the operations of:
receiving, by the second station, the cellular packet transmitted by the first station, the cellular packet being configured to be routed by cellular routing via a base station within a cellular network;
extracting a packet, called a geo-network packet, from the cellular packet, the geo-network packet being configured to be routed by multi-hop geographic routing within a short-range network, the extraction being implemented by a layer that is lower than or equal to the network layer;
generating a segment from the geo-network packet;
transmitting the segment to a transport layer or to a layer above the transport layer.

H. A vehicle comprising the device according to aspect F. and/or aspect G.

A second set of aspects related to the method described above is described below with reference to FIG. 2:

α. A method for transmitting a segment from a first station, a station being a vehicle, a road infrastructure, or a personal device of a pedestrian, to a second station, the method comprising the steps of:
generating a packet, called a geo-network packet, from the segment, at least, the segment coming from a transport layer or from a layer above the transport layer, the geo-network packet being configured to be routed by multi-hop geographic routing within a short-range network;
processing the geo-network packet in order to generate a packet, called a cellular packet, the cellular packet comprising the useful data and being configured to be routed by cellular routing via at least one base station within a cellular network, the processing being implemented by a layer (56, 58, 60) that is lower than or equal to the network layer (48);
transmitting the cellular packet to the second station via the cellular network;
transmitting the geo-network packet to the second station via the short-range network.

The method according to aspect a thus makes it possible to duplicate the transmission of a segment via the short-range network on the basis of multi-hop geographic routing and via the cellular network on the basis of cellular routing.

The redundancy introduced in this manner makes the transfer of the segment from the first station to the second station more reliable. In effect, the failures of transit stations and errors linked to excessive latencies are directly resolved whenever the cellular network is available to transfer the segment.

Furthermore, these problems can be resolved indirectly when the cellular network is only available intermittently, as is frequently the case with a connected motor vehicle. In this situation, a buffer memory can store the cellular packets to be transferred once the cellular network is available again.

Whatever the manner, direct or indirect, of solving these problems, the redundancy introduced by the duplication of the transmission makes a reliable check of the coherence of the transmitted segments possible.

The precision of many functions typically associated with an autonomous vehicle is thereby improved. For example, in order to make a position of a vehicle given by a GNSS (Global Navigation Satellite System) satellite navigation system more reliable, a triangulation process is used that employs communications between vehicles. The duplication of the transmission of the segment greatly improves the reliability of the inter-vehicle distance data and thus the precision of the position measurement given by triangulation.

What is more, since the processing of the geo-network packet in order to generate the cellular packet is implemented in the network layer or below, the steps implemented for transmission are advantageously reduced. In particular, it is not necessary to double the processing steps of the transport and upper layers, which are very costly in terms of time and computing resources. For example, it is not necessary to sign the segments/datagrams for the short-range network and for the cellular network.

Such signature steps are particularly cumbersome for networks in charge of communications between stations in the form of a vehicle, a road infrastructure, and/or a personal device of a pedestrian. Thus, the processing of cooperative awareness messages (CAMs) and of decentralized environmental notification messages (DENMs), or also the RSA signatures introduce delays of approximately 30 ms in the layers above the network layer for segments that are intended to be sent by multi-hop geographic routing.

The transmission implemented in this manner thus substantially and efficiently improves the possibilities for communication between stations and, in particular, makes very reliable communication possible without introducing processing steps that are costly in terms of time and computation resources.

In addition, “processing the geo-network packet in order to generate a cellular packet” is understood to mean any type of processing that uses the geo-network packet in particular in order to generate, in particular, the cellular packet. This feature is therefore not limited to the generation of a single cellular packet by a single geo-network packet but also covers the generation of a cellular packet by a plurality of geo-network packets and other data or even the generation of multiple cellular packets from a single geo-network packet.

The term “road infrastructure” is understood to mean any infrastructure for any type of vehicle that is linked to or located in an environment close to a road. A toll barrier, a sign, a fence in a park, or even a processing center in charge of roads that is located in a particular geographic area are examples of road infrastructures.

β. The method according to aspect α, in which the cellular packet is transmitted to the data link layer or to the lower layer in the data link layer for transmission to the second station via the short-range network or via the cellular network.

γ. The method according to aspect α, in which the step of processing the geo-network packet comprises the sub-steps of:
generating information for cellular routing through the base station within the cellular network;
adding to the geo-network packet a header comprising the information for cellular routing.

δ. A method for receiving a segment by a second station, a station being a vehicle, a road infrastructure, or a personal device of a pedestrian, the segment having been transmitted by a first station, the method comprising the steps of:
receiving by the second station of a packet, called a cellular packet, transmitted by the first station, the cellular packet being configured to be routed by cellular routing via a base station within a cellular network;
receiving by the second station of a first geo-network packet transmitted by the first station, a geo-network packet being configured to be routed by multi-hop geographic routing within a short-range network;
extracting a second geo-network packet from the cellular packet, the extraction being implemented by a layer that is lower than or equal to the network layer;
generating the segment from the first and/or the second geo-network packet.

Analogously to what was detailed above for the transmission, aspect δ. thus makes duplicate reception of the geo-network packet and the segment it contains possible.

Thus, and in the same manner as for the transmission, the reception implemented in this manner thus substantially and efficiently improves the possibilities for communication between stations and, in particular, makes very reliable communication possible without introducing processing steps that are costly in terms of time and computation resources.

ϵ. The method according to aspect δ, in which the segment is generated from the geo-network packet from among the first geo-network packet and the second geo-network packet that is the first to be received.

Thus, the introduction of redundancy does not penalize the execution speed of the transmission of the segment. In addition, a redundancy check based on the duplicate reception of the packets can be performed in any case, particularly a posteriori (once the first received packet has been transmitted to the application layers).

ζ. The method according to aspect δ, in which the segment is generated from the geo-network packet from among the first geo-network packet and the second geo-network packet for which the result of a redundancy check is the most favorable.

This ensures maximum reliability of the transmission, since the selection of the packet to be transmitted to the upper layers is made on the basis of the redundancy check and no longer as a function of the first packet received.

η. The method according to at least one of the aspects αto ζ., in which the short-range network is an ITS-G5 network and/or the cellular network is a 2G mobile network, a 3G mobile network, a 4G mobile network, or a 5G mobile network.

θ. A device comprised within a first station, a station being a vehicle, a road infrastructure, or a personal device of a pedestrian, for transmitting a segment from the first station to a second station, the device comprising at least one processor and one memory configured to perform the operations of:
generating a packet, called a geo-network packet, from the segment, at least, the segment coming from a transport layer or from a layer above the transport layer, the geo-network packet being configured to be routed by multi-hop geographic routing within a short-range network;
processing the geo-network packet in order to generate a packet called a cellular packet, the cellular packet being configured to be routed by cellular routing through a base station within a cellular network, the processing being implemented by a layer lower or equal to the network layer;
transmitting the cellular packet to the second station via the cellular network;
transmitting the geo-network packet to the second station via the short-range network.

80 . A device comprised within a second station, a station being a vehicle, a road infrastructure, or a personal device of a pedestrian, for receiving a segment by the second station from a first station, the device comprising at least one processor and one memory configured to perform the operations of:
receiving by the second station of a packet, called a cellular packet, transmitted by the first station, the cellular packet being configured to be routed by cellular routing via a base station within a cellular network;
receiving by the second station of a first geo-network packet transmitted by the first station, a geo-network packet being configured to be routed by multi-hop geographic routing within a short-range network;
extracting a second geo-network packet from the cellular packet, the extraction being implemented by a layer that is lower than or equal to the network layer;
generating the segment from the first and/or the second geo-network packet.

μ. A vehicle comprising the device according to the aspect θ and/or aspect λ.

The present invention is not limited to the embodiments described above by way of example, but rather it extends to other variants.

For instance, an example was described above in which the stations were motor vehicles. The invention is not limited to such an example, and the stations can also be a personal device of a pedestrian or a road infrastructure.

1. A method for relaying an item of useful data by way of a transit station, the item of useful data passing through the transit station from a first station to a second station, each of said stations being a vehicle, a road infrastructure, or a personal device of a pedestrian, the method comprising the steps, implemented by the transit station, of:
receiving from the first station and by means of a short-range network based on multi-hop geographic routing a geo-network packet, the geo-network packet comprising the item of useful data and being configured to be routed by the multi-hop geographic routing of the short-range network;
processing the geo-network packet in order to generate a cellular packet, the cellular packet comprising the item of useful data and being configured to be routed by cellular routing via at least one base station within a cellular network, the processing being implemented by a layer that is lower than or equal to the network layer;
transmitting the cellular packet to the second station via the cellular network.

2. The method according to claim 1, wherein the step of processing the geo-network packet comprises the sub-steps of:
generating information for cellular routing through the base station within the cellular network;
adding to the geo-network packet a header comprising the information for cellular routing.

3. The method according to claim 2, wherein the geo-network packet comprises the useful data and information for multi-hop geographic routing, and
wherein the information for cellular routing is obtained from the information for geographic routing.

4. The method according to claim 2, wherein the geo-network packet comprises the useful data and information for multi-hop geographic routing,
wherein the information for cellular routing is obtained from the information for geographic routing, and
wherein the step of adding the header to the geo-network packet consists in concatenating the header comprising the information for cellular routing to the geo-network packet.

5. The method according to claim 1, wherein a verification of a transit authorization criterion is performed prior to the processing step, and the processing and transmission steps are not implemented in the event that the verification is negative,
wherein the transit authorization criterion being at least one of the following elements:
a fixed control parameter;
a variable control parameter;
a criticality parameter for the item of useful data;
a type of station.

6. The method according to claim 5, wherein the transit authorization criterion comprises at least the variable control parameter,
wherein the variable control parameter is updated in at least one of the following situations:
updating at the predetermined interval;
updating during a station maintenance operation;
powering-on of the station.

7. A method for relaying an item of useful data by way of a transit station, the item of useful data passing through the transit station from a first station to a second station, each of said stations being a vehicle, a road infrastructure, or a personal device of a pedestrian, the method comprising the steps, implemented by the transit station, of:
receiving from the first station and by means of a cellular network (62) based on cellular routing via at least one base station a cellular packet, the cellular packet comprising the item of useful data and being configured to be routed by cellular routing within the cellular network;
processing the cellular packet in order to generate a geo-network packet, the geo-network packet comprising the item of useful data and being configured to be routed by multi-hop geographic routing on a short-range network, the processing being implemented by a layer that is lower than or equal to the network layer;
transmitting the geo-network packet to the second station via the short-range network.

8. The method according to claim 7, wherein the step of processing the cellular packet comprises extracting the geo-network packet from the cellular packet, and
wherein the extraction is performed by removing a header from the cellular packet, the header comprising information for cellular routing via the base station within the cellular network.

9. The method according to claim 7, wherein a verification of a transit authorization criterion is performed prior to the processing step, and the processing and transmission steps are not implemented in the event that the verification is negative,
the transit authorization criterion being at least one of the following elements:
a fixed control parameter;
a variable control parameter;
a criticality parameter for the item of useful data;
a type of station.

10. The method according to claim 9, wherein the transit authorization criterion comprises at least the variable control parameter,
the variable control parameter being updated in at least one of the following situations:
updating at the predetermined interval;
updating during a station maintenance operation;
powering-on of the station.

11. A computer program comprising instructions for implementing the method according to claim 1 when these instructions are executed by a processor.

12. A device for relaying an item of useful data that is connected to a transit station, the item of useful data passing through the transit station from a first station to a second station, each of said stations being a vehicle, a road infrastructure, or a personal device of a pedestrian, the device comprising at least one processor and one memory designed to perform the operations of:
receiving from the first station and by means of a short-range network (54) based on multi-hop geographic routing a geo-network packet, the geo-network packet comprising the item of useful data and being configured to be routed by the multi-hop geographic routing of the short-range network;
processing the geo-network packet in order to generate a packet, called a cellular packet, the cellular packet comprising the item of useful data and being configured to be routed by cellular routing via at least one base station within a cellular network (62), the processing being implemented by a layer that is lower than or equal to the network layer;
transmitting the cellular packet to the second station via the cellular network.

13. A device for relaying an item of useful data that is connected to a transit station, the item of useful data passing through the transit station from a first station to a second station, each said station being a vehicle, a road infrastructure, or a personal device of a pedestrian, the device comprising at least one processor and one memory designed to perform the operations of:
receiving from the first station and by means of a cellular network (62) based on cellular routing via at least one base station a packet a cellular packet, the cellular packet comprising the item of useful data and being configured to be routed by cellular routing within the cellular network;
processing the cellular packet in order to generate a geo-network packet, the geo-network packet comprising the item of useful data and being configured to be routed by multi-hop geographic routing on a short-range network (54), the processing being implemented by a layer that is lower than (50, 52) or equal (48) to the network layer;
transmitting the geo-network packet to the second station via the short-range network.
